(19) United States
(12) Patent Application Publication
(10) Pub. No.: US 2017/0021453 A1
(43) Pub. Date: Jan. 26, 2017

(54) GAMMA PRIME PRECIPITATION STRENGTHENED NICKEL-BASE SUPERALLOY FOR USE IN POWDER BASED ADDITIVE MANUFACTURING PROCESS

(71) Applicant: GENERAL ELECTRIC TECHNOLOGY GMBH, Baden, OT (CH)

(72) Inventors: Roman ENGELI, Zürich (CH); Thomas ETTER, Muhen (CH); Hossein MEIDANI, Zürich (CH)

(73) Assignee: GENERAL ELECTRIC TECHNOLOGY GMBH, Baden, OT (CH)

(21) Appl. No.: 15/107,001

(22) PCT Filed: Dec. 9, 2014
(86) PCT No.: PCT/EP2014/077060

§ 371 Date: Jun. 21, 2016

(30) Foreign Application Priority Data
Dec. 23, 2013 (EP) 13199285.1

(51) Int. Cl. B23K 26/342; B23K 26/00; C22C 19/05; B22F 1/00; B33Y 10/00; B33Y 70/00

(52) U.S. Cl. CPC B23K 26/342; B33Y 10/00; B33Y 70/00; C22C 19/056; B22F 1/0003; B23K 26/0006; B22F 2302/45; B23K 2203/08

(57) ABSTRACT

The application relates to the technology of producing three-dimensional articles by powder-based additive manufacturing, such as selective laser melting or electron beam melting. Especially, it refers to a high oxidation resistant and high gamma-prime precipitation containing Ni-base super alloy powder on basis of IN738LC with a modified chemical composition. Such powder has the following chemical composition (in wt.-%): 15.7-16.3 Cr, 8.0-9.0 Co, 1.5-2.0 Mo, 2.4-2.8 W, 1.5-2.0 Ta, 3.2-3.7 Al, 2.2-3.7 Ti, 0.6-1.1 Nb, 0.09-0.13 C, 0.007-0.012 B, 0.0045≦Zr<0.03, 0.001≦Si<0.03, remainder Ni and unavoidable residual elements and in addition a powder size distribution between 10 and 100 μm and a spherical morphology. As an advantage nearly crack free three-dimensional articles can be produced with more productive process parameters and without complicated and time consuming variations of the addive manufacturing processes (e.g. pre-heating) and/or post processing (e.g. hot isostatic pressing HIP).

### BACKGROUND OF THE INVENTION

The present invention relates to the technology of producing three-dimensional articles by means of powder-based additive manufacturing, such as selective laser melting (SLM) or electron beam melting (EBM). Especially, it refers to a high oxidation resistant and high gamma-prime (γ′) precipitation containing Ni-base super alloy powder on basis of IN738LC with a modified chemical composition for manufacturing of nearly crack free components.

### PRIOR ART

Gamma-prime (γ′) precipitation-strengthened nickel-base superalloys with a combined fraction of Al and Ti of about more than 5 wt.-% are known to be very difficult to weld because of their micro-crack sensitiveness. Micro-cracking during welding of those superalloys, such as IN738LC, MARM-M 247 or CM247LC is attributed to the liquation of precipitates or low-melting eutectics in the heat affected zone (HAZ), ductility dip cracking (DDC) or strain-age cracking in subsequent heat treatment.

In the document: B. Geddes, H. Leon, X. Huang: Superalloys, Alloying and performance, ASM International, 2010, page 71-72, the authors describe a weldability line for superalloys approximately as [two times Al concentration (in wt.-%)+Ti concentration (in wt. %)]<6.0, this means that Ni base superalloys with more than 6 wt.-% of [2 times Al (in wt.-%)+Ti (in wt.-%)] are defined as difficult to weld materials. Solidification and grain boundary liquation cracking occurs during the welding process, whereas post-weld heat treatments often lead to strain age cracking in gamma-prime Ni₃(Al,Ti) precipitate strengthened alloys.

Therefore, mainly solid-solution strengthened (e.g. IN625) or gamma-prime strengthened nickel-base superalloys with a low amount of Al and Ti (e.g. IN718) are processed by SLM or EBM so far.

Document DE 10 2009 050 563 A1 describes a Ni-base superalloy for use in additive manufacturing, preferably laser melting, with a defined Ti-content from 0.3 to 1.2 wt.-% and/or an Al-content from 2.5 to 5.7 wt.-% with a preferred total content of Ti and Al in a range from 2.8 to 5.0 wt.-%.

In a common approach to process difficult to weld gamma-prime precipitation-strengthened nickel-base superalloys, a powder bed is heated to an elevated temperature to reduce residual stresses resulting from the welding process. But, before the finished parts can be removed from the powder bed, it has to be cooled down to ambient temperature. Due to the low heat conductivity of powder beds, the heating up and cooling down of the powder bed requires a lot of time resulting in a significant decrease in productivity of the SLM process. Furthermore expensive heating equipment and isolation as well as adaptation of the process chamber are needed.

EP 2 589 449 Al discloses a SLM process for the production of crack-free and dense three-dimensional articles made of difficult to weld gamma-prime precipitation-strengthened Nickel-base superalloy wherein the laser power, focus diameter of the focal spot and the scan speed of said focused laser beam are adjusted to obtain heat dissipation welding.

In general, SLM generated articles have different microstructures compared to cast material of the same alloy. This is primary due to powder based layer-by-layer article production and the inherent high cooling rates due to the high energy beam/material interaction in these processes. Due to the extremely localized melting and the resulting rapid solidification during SLM, segregation of alloying elements and formation of precipitations is considerably reduced, which results in a decreased sensitivity for cracking compared to conventional build-up welding techniques.

By using commercially available IN738LC powder for the SLM process unfortunately microcracks are still present in the manufactured articles. This was for example confirmed in a presentation by Fraunhofer Institute for Laser Technology (J. Risse, C. Golebiewski, W. Meiners, K. Wissenbach: Influence of process management on crack formation in nickel-based alloy parts (IN738LC) manufactured by SLM, RapidTech, 14./15.05.2013, Erfurt). It was stated there that crack free articles can only be manufactured with an extensive preheating.

However, the applicant has found out that by using IN738LC with adjusted chemistry, SLM allows the near-net shape processing of this difficult to weld material. A high Al and Ti content of gamma-prime (γ′) precipitation-strengthened nickel-base superalloys is not the main reason for cracking and that hot cracking susceptibility of SLM processed IN738LC cannot be predicted by classic weldability charts.

### SUMMARY OF THE INVENTION

It is an object of the present invention to provide a Nickel-base superalloy powder with high gamma-prime precipitation content for additive manufacturing (SLM, EBM) of three-dimensional articles with a reduced hot cracking tendency and disclose suitable process parameter for manufacturing such an article. The modified composition of the powder according to the present invention is based on known commercially available Inconel 738 (IN738LC) powder with a specification of (in wt.-%): 15.7-16.3 Cr, 8.0-9.0 Co, 1.5-2.0 Mo, 2.4-2.8 W, 1.5-2.0 Ta, 3.2-3.7 Al, 2.2-3.7 Ti, 0.6-1.1 Nb, 0.09-0.13 C, 0.007-0.012 B, 0.03-0.08 Zr, max. 0.3 Si, remainder Ni and unavoidable residual elements (impurities).

This object is realized by a powder composition according to claim 1 with a powder size distribution between 10 and 100 μm and a spherical morphology.

The core of the invention is that by a tight control and modification of specific minor/trace elements (0.004≦Zr<0.03 wt.-% and 0.001≦Si<0.03 wt.-%) in the IN738LC alloy powder with the above-mentioned powder size distribution and morphology of the powder crack free or at least nearly crack free components can be produced by SLM without preheating. It was found that the known limitation of maximal 0.3 wt.-% Si and maximal 0.08 wt.-% Zr for commercially available IN738LC powder is too high for use of this powder in powder based additive manufacturing, like SLM or EBM. In contrast to the state of the art knowledge not the (Al+Ti) content is limiting the processability, but the minor concentrations of Si and Zr.

In preferred embodiments the Si content of the powder is max. 0.02 wt.-% and/or the Zr content is max. 0.02 wt.-%.

The SLM process parameters are chosen such that the Laser area energy density E_{D} during SLM process is according to the invention in the range between 0.5-10 J/mm². E_{D} is calculated as follows:

$${E}_{D} = \frac{{P}_{L}}{{V}_{S} \cdot {D}_{B}}$$

with P_{L}: Laser Power [W]
V_{S}: Scan velocity [mm/s]
D_{B}: Laser beam diameter [mm].

According to a preferred embodiment of the invention the Laser area energy density is between 0.8 and 5 J/mm², preferably between 1-3.5 J/mm².

According to another embodiments of the invention the layer thickness of each SLM layer is in the range of 0.01-0.1 mm, preferably 0.02-0.05 mm and most preferably 0.03-0.04 mm. Then nearly crack free components, for example gas turbine components, can be produced.

### BRIEF DESCRIPTION OF THE DRAWINGS

The present invention is now to be explained more closely by means of different embodiments and with reference to the attached drawings.

FIG. 1 shows the microstructure of a SLM test probe made of standard IN738LC powder (prior art) with a high density of microcracks;

FIG. 2 shows the microstructure of a SLM test probe made of a modified powder according to a first embodiment of the invention with a reduced density of microcracks compared to FIG. 1;

FIG. 3 shows in detail the average crack density for using the prior art powder and for using several embodiments according to the present invention;

FIG. 4 shows the crack density dependency on the Zr content in the tested powder and

FIG. 5 shows the crack density dependency on the Si content in the tested powder.

### DETAILED DESCRIPTION OF DIFFERENT EMBODIMENTS OF THE INVENTION

As described above it was found out that a high Al and Ti content of gamma-prime (γ′) precipitation-strengthened nickel-base superalloys is not the main reason for cracking and that hot cracking susceptibility of SLM processed IN738LC powder cannot be predicted by classic weldability charts. In contrast, a tight control of specific minor/trace elements (Zr, Si) is necessary as well as using a powder with a powder size distribution between 10 and 100 μm and a spherical morphology.

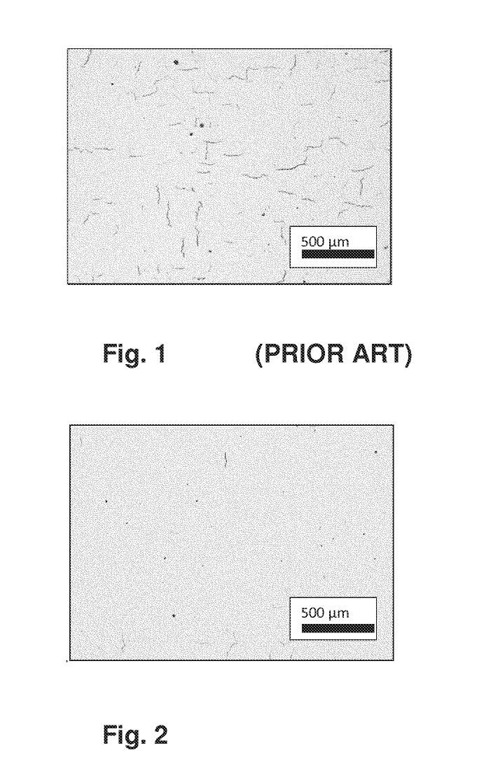

FIG. 1 shows the microstructure of a SLM test probe (three-dimensional article) made of standard IN738LC powder (commercial available prior art) with a specification of (in wt.-%): 15.7-16.3 Cr, 8.0-9.0 Co, 1.5-2.0 Mo, 2.4-2.8 W, 1.5-2.0 Ta, 3.2-3.7 Al, 2.2-3.7 Ti, 0.6-1.1 Nb, 0.09-0.13 C, 0.007-0.012 B, 0.03-0.08 Zr, max. 0.3 Si, remainder Ni and unavoidable residual elements (impurities). IN738LC is high oxidation resistant and has a high content of gamma-prime (γ′) precipitations. The details are for Zr content 0.06 wt.-% and for Si content 0.085 wt.-%. It can be seen in FIG. 1, that the probe according to the prior art has a high density of microcracks.

The core of the invention is that by a tight control and modification of specific minor/trace elements (0.004≦Zr<0.03 wt.-% and 0.001≦Si<0.03 wt.-%) in the IN738LC alloy powder with the above-mentioned powder size distribution and morphology of the powder crack free or at least nearly crack free components (three-dimensional articles) can be produced by SLM without preheating. It was found that the known limitation of maximal 0.3 wt.-% Si and 0.08 wt.-% Zr for commercially available IN738LC powder is too high for use of this powder in powder based additive manufacturing, like SLM, EBM. In contrast to the state of the art knowledge not the (Al+Ti) content is limiting the processability, but the minor concentrations of Si and Zr.

Therefore, several Nickel-base powders with a chemical composition of 15.7-16.3 Cr, 8.0-9.0 Co, 1.5-2.0 Mo, 2.4-2.8 W, 1.5-2.0 Ta, 3.2-3.7 Al, 2.2-3.7 Ti, 0.6-1.1 Nb, 0.09-0.13 C, 0.007-0.012 B, 0.004≦Zr<0.03, 0.001≦Si<0.03, remainder Ni and unavoidable residual elements and with powder size distribution between 10 and 100 μm and a spherical morphology were tested for additive manufacturing of three-dimensional articles.

FIG. 2 shows a first embodiment of the invention. The article was produced by SLM with a powder according to the invention, here with Zr<0.03 wt.-% and Si=0.0176 wt.-%. During the layer by layer built up of the article the Laser power P_{L}, the scan velocity Vₛ and the Laser beam diameter of SLM were chosen/applied such that the Laser area energy density E_{D} was in the range between 0.5-10 J/mm²′, here in detail E_{D} was 1.8 J/mm². Preferred ranges of the Laser area energy density are 0.8-5 J/mm², more preferred 1-3.5 J/mm².

It can be seen in FIG. 2 that the probe according to the invention has only a very low microcrack density compared to FIG. 1.

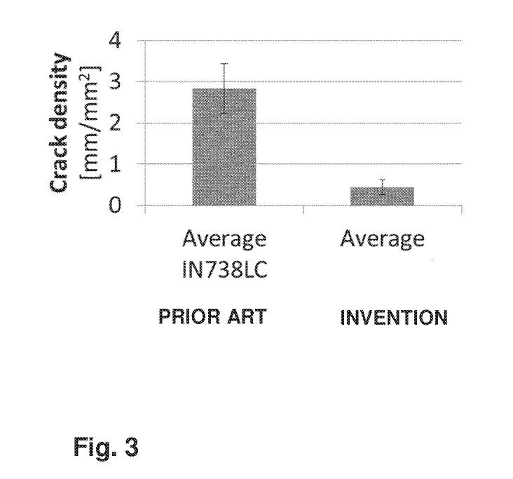

In FIG. 3 is shown in detail the average crack density for using the prior art powder and for using several embodiments according to the present invention. The tight control of the elements Si and Zr considerably reduces hot cracking during SLM or EBM, resulting in defect densities which are by a factor of 6 lower compared to the commercial available IN738LC.

Therefore, nearly crack free three-dimensional articles can be produced with more productive process parameters and without complicated and time consuming variations of the addive manufacturing processes (e.g. pre-heating) and/or post processing (e.g. hot isostatic pressing HIP).

Each of the layers applied within the SLM or EBM process have a thickness in the range of 0.01-0.1 mm, preferably in the range of 0.02-0.05 mm. A more preferred range is 0.03-0.04 mm.

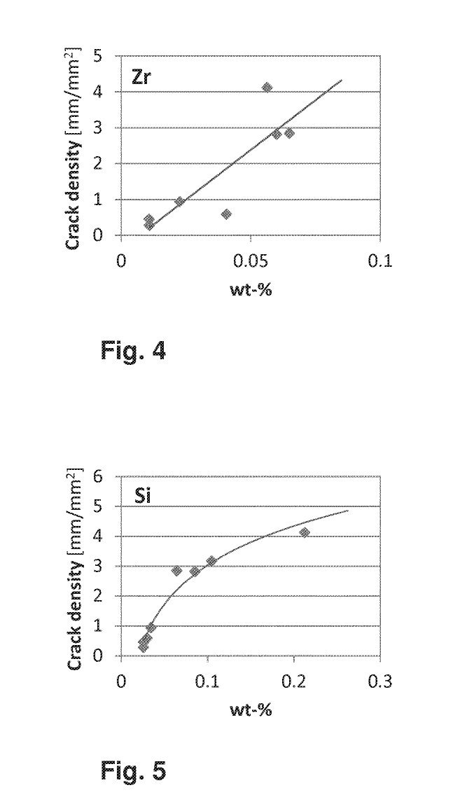

In FIG. 4 is shown as an example for different SLM probes made of IN738LC powder the crack density dependency on the Zr content in the tested powder and in FIG. 5 the crack density dependency on the Si content in the tested powder.

Much reduced crack density is received for the disclosed ranges (in wt.-%) of 0.004≦Zr<0.03 and 0.001≦Si<0.03. Max. 0.02 wt.-% Zr and/or max 0.02 wt.-% Si are preferred because of the nearly microcrack free microstructure.

Of course, the invention is not limited to the decribed embodiments. For example, it is expected that the disclosed nickel-base superalloy powder is applicable not only for SLM manufacturing process but also for EMB manufacturing process with the described advantages.

1. Nickel-base superalloy powder comprising: a high gamma-prime precipitation content for additive manufacturing of three-dimensional articles wherein the powder has the following chemical composition (in wt.-%): 15.7-16.3 Cr, 8.0-9.0 Co, 1.5-2.0 Mo, 2.4-2.8 W, 1.5-2.0 Ta, 3.2-3.7 Al, 2.2-3.7 Ti, 0.6-1.1 Nb, 0.09-0.13 C, 0.007-0.012 B, 0.0045≦Zr<0.03, 0.001≦Si<0.03, remainder Ni and unavoidable residual elements and wherein the powder has a powder size distribution between 10 and 100 μm and a spherical morphology.

2. Nickel-base superalloy powder according to claim 1, wherein the Si content is max. 0.02 wt.-%.

3. Nickel-base superalloy powder according to claim 1, wherein the Zr content is max. 0.02 wt.-%.

4. SLM process for additive manufacturing of three-dimensional articles with a Nickel-base superalloy powder containing a high gamma-prime precipitation content for additive manufacturing of three-dimensional articles wherein the powder has the following chemical composition (in wt.-%): 15.7-16.3 Cr, 8.0-9.0 Co, 1.5-2.0 Mo, 2.4-2.8 W, 1.5-2.0 Ta, 3.2-3.7 Al, 2.2-3.7 Ti, 0.6-1.1 Nb, 0.09-0.13 C, 0.007-0.012 B, 0.004≦Zr<0.03, 0.001≦Si<0.03, remainder Ni and unavoidable residual elements and wherein the powder has a powder size distribution between 10 and 100 μm and a spherical morphology wherein the process comprises: a Laser power P_{L}, a scan velocity Vₛ and a Laser beam diameter D_{B} during a layer by layer built-up of the article which are applied such that the Laser area energy density E_{D} is in a range between 0.5-10 J/mm².

5. SLM process according to claim 4, wherein the Laser area energy density E_{D} is between 0.8 and 5 J/mm².

6. SLM process according to claim 5, wherein the Laser area energy density E_{D} is between 1-3.5 J/mm².

7. SLM process according to claim 4, wherein layers are applied with a thickness of each layer in the range of 0.01-0.1 mm.

8. SLM process according to claim 7 wherein layers are applied with a thickness of each layer in the range of 0.02-0.05 mm.

9. SLM process according to claim 8 wherein layers are applied with a thickness of each layer in the range of 0.03-0.04 mm.
